(19) United States
(12) Patent Application Publication
(10) Pub. No.: US 2004/0183781 A1
(43) Pub. Date: Sep. 23, 2004

(54) Mouse having blue tooth transforming device

(76) Inventors: Acer Ye, Hsin Chuang City (TW); Author Pan, Hsin Chuang City (TW)

Correspondence Address: Acer Ye, P.O. Box 4-67, Hsin Chuang, Taipei, 242, TW

(21) Appl. No.: 10/394,564

(22) Filed: Mar. 19, 2003

(51) Int. Cl. G09G 5/08

(52) U.S. Cl. 345/163

(57) ABSTRACT

A blue tooth mouse assembly includes an interface module having a USB coupler for coupling to computer facility and an interface switching device coupled to the USB coupler. A mouse module includes an interface device coupled to the interface module, an electric power supply circuit coupled to the interface device to receive electric power from the computer facility, and a detecting device to detect coordinate signals and movement signals of the blue tooth mouse assembly to the computer facility. A blue tooth module is coupled to the interface module, and includes a signal transforming device and an antenna to receive and send signals.

### BACKGROUND OF THE INVENTION

1. Field of the Invention

The present invention relates to a mouse, and more particularly to a blue tooth mouse assembly having a blue tooth transforming device for wirelessly communicating with the other end users.

2. Description of the Prior Art

Typical computer mice have been widely used to couple to various kinds of computer facilities, such as personal computers, notebook computers, personal digital assistants (PDA), etc., for operating or controlling the computer facilities and/or the peripheral facilities that are coupled to the computer facilities. Normally, the typical computer mice are coupled to computer facilities with electric cables.

However, additional batteries or other electrical power sources are required to be further provided and coupled to the typical computer mice, in order to energize the typical computer mice. For example, when in vehicles, both the notebook computers and the mice may required to be coupled to the electrical power sources of the vehicles separately, for allowing the notebook computers and the mice to be energized by the electric power source of the vehicles separately.

Furthermore, additional antenna and/or the other wireless transforming or communicating devices are further required to be purchased and coupled to the computer facilities separately, for allowing the computer facilities to be communicated with the other end users wirelessly.

It is expensive and inconvenient for the users to purchase and couple or connect the antenna and/or the other wireless transforming or communicating devices to the computer facilities.

The present invention has arisen to mitigate and/or obviate the afore-described disadvantages of the conventional mice for computer facilities.

### SUMMARY OF THE INVENTION

The primary objective of the present invention is to provide a blue tooth mouse assembly for wirelessly communicating the computer facilities to the other end users.

In accordance with one aspect of the invention, there is provided a blue tooth mouse assembly comprising an interface module including a USB coupler for coupling to computer facility, and including an interface switching device coupled to the USB coupler, a mouse module including an interface device coupled to the interface switching device of the interface module, an electric power supply circuit coupled to the interface device of the mouse module, to receive electric power from the computer facility, and a detecting device coupled to the electric power supply circuit, to detect and send coordinate signals and movement signals of the blue tooth mouse assembly to the computer facility via the interface device of the mouse module and the interface module. A blue tooth module is further provided and includes an interface device coupled to the interface switching device of the interface module, a signal transforming device coupled to the interface device of the blue tooth module, to transform signals to and from the computer facility, and an antenna coupled to the signal transforming device to receive and send signals from and out of the computer facility, for wirelessly communicating the computer facilities to the other end users, or for allowing various end users to communicate with each other. No electric power supply or batteries are required to be coupled to the blue tooth mouse assembly.

The blue tooth module further includes an electric power supply device coupled to the interface device of the blue tooth module, to receive electric power from the computer facility.

The blue tooth module further includes a blue tooth control device coupled to the signal transforming device of the blue tooth module.

The mouse module further includes a mouse control device coupled to the electric power supply circuit of the mouse module, to control the sending or transmission of the coordinate signals and movement signals of the blue tooth mouse assembly to the computer facility.

The mouse module further includes a button control device coupled to the mouse control device, to control the mouse control device.

The mouse module further includes a signals transmitting device coupled between the mouse control device and the detecting device, to transmit signals between the mouse control device and the detecting device.

Further objectives and advantages of the present invention will become apparent from a careful reading of the detailed description provided herein below, with appropriate reference to the accompanying drawings.

### BRIEF DESCRIPTION OF THE DRAWINGS

FIG. 1 is a perspective schematic view illustrating the computer facilities to be operated or communicated with a blue tooth mouse assembly in accordance with the present invention;

FIG. 2 is a block diagram illustrating the parts or members or elements of the blue tooth mouse assembly;

FIG. 3 is a block diagram illustrating the parts or members or elements of the wireless communicating portion or device of the blue tooth mouse assembly; and

FIG. 4 is a block diagram illustrating the parts or members or elements of the blue tooth mouse assembly.

### DETAILED DESCRIPTION OF THE PREFERRED EMBODIMENT

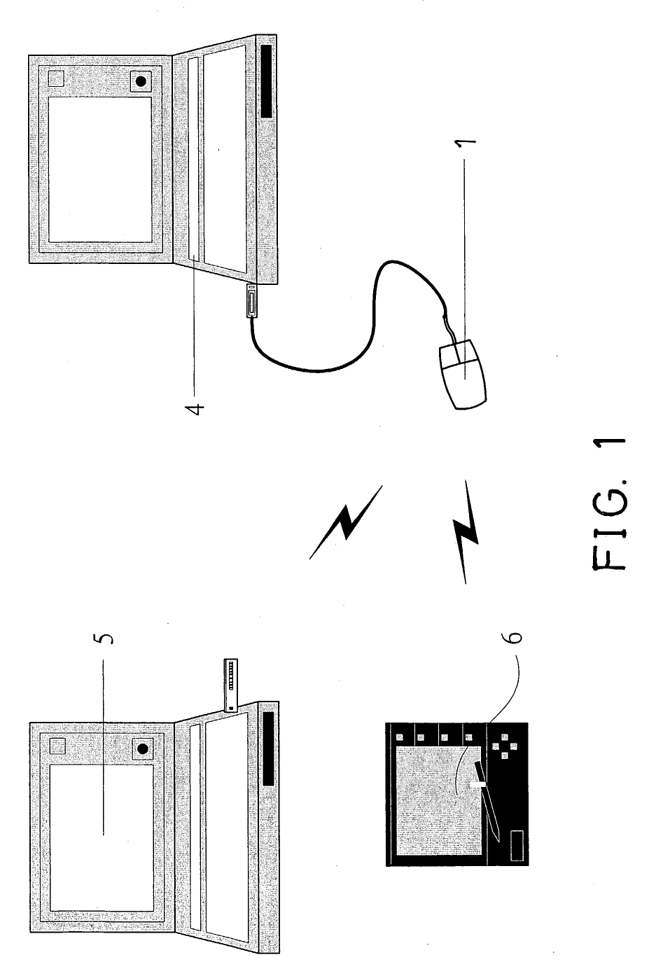

Referring to the drawings, and initially to FIG. 1, a mouse in accordance with the present invention is a blue tooth mouse assembly 1 for coupling to various kinds of computer facilities 4, such as personal computers, notebook computers, personal digital assistants (PDA), etc., and for wirelessly communicating with the other end users 5 or PDAs 6.

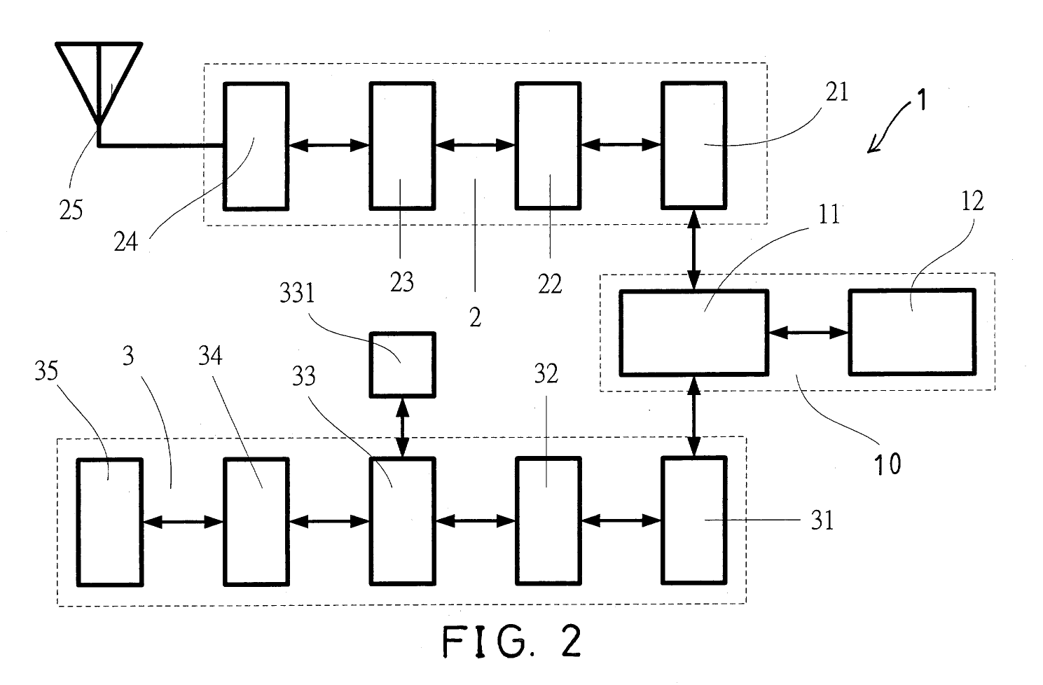

As shown in FIG. 2, the blue tooth mouse assembly 1 comprises an interface facility or module 10, and a blue tooth facility or module 2 and a mouse facility or module 3 coupled to the interface module 10. The interface module 10 is provided for coupling to various kinds of computer facilities 4, and the blue tooth module 2 is provided for wirelessly communicating purposes.

The interface module 10 includes an interface switching device 11 coupled to and communicated between the blue tooth module 2 and the mouse module 3, and a coupler, such as a universal serial bus (USB) coupler 12 coupled to the interface switching device 11, for coupling to various kinds of computer facilities 4, and thus for coupling the blue tooth mouse assembly 1 to the computer facilities 4.

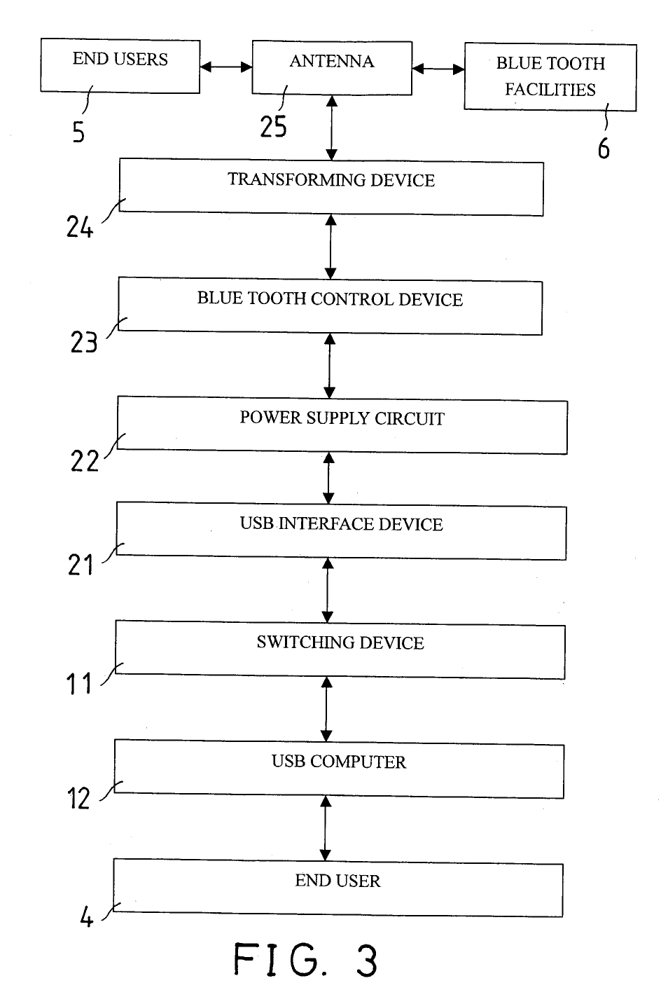

As shown in FIGS. 2 and 3, the blue tooth module 2 includes a universal serial bus (USB) interface circuit or card or device 21 coupled to the interface switching device 11 of the interface module 10, for communicating the blue tooth module 2 with the interface module 10, and includes an electric power supply circuit 22 coupled to the blue USB interface device 21 for obtaining electric power from such as the computer facilities 4, and in order to energize the blue tooth module 2.

The blue tooth module 2 further includes a blue tooth control chip or integrated circuit or blue tooth processor or control device 23 coupled to the electric power supply circuit 22, a signal treating or processing or converting or transforming device 24 coupled to the blue tooth control device 23, and an antenna 25 coupled to the signal converting or transforming device 24, for transmitting signals out from the computer facilities 4 or for receiving signals from the other computer facilities 5, 6.

For example, the signals from the computer facilities 4 or from the mouse module 3 may be converted by the signal converting or transforming device 24, into the signals that may be transmitted out via the antenna 25. On the contrary, the signals received from the other computer facilities 5, 6 via the antenna 25 may also be converted by the signal converting or transforming device 24, and then sent or transmitted to the computer facilities 4.

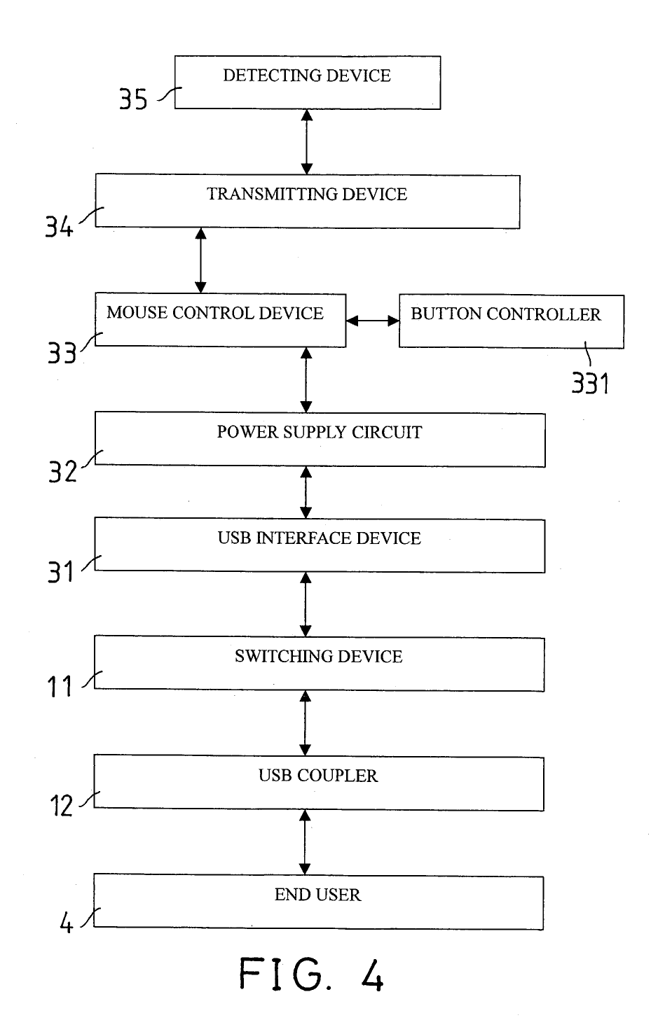

As shown in FIGS. 2 and 4, the mouse module 3 includes a universal serial bus (USB) interface circuit or card or device 31 coupled to the interface switching device 11 of the interface module 10, for communicating the mouse module 3 with the interface module 10, and includes an electric power supply circuit 32 coupled to the blue USB interface device 31 for obtaining electric power from such as the computer facilities 4, and in order to energize the mouse module 3.

The mouse module 3 further includes a mouse control chip or integrated circuit or processor or control device 33 coupled to the electric power supply circuit 32, a signal transmitting device 34 coupled to the mouse control device 33, a detecting device 35 coupled to the signal transmitting device 34, and a button control circuit or device 331 coupled to the mouse control device 33.

The detecting device 35 may be provided to detect and send the coordinate signals and/or the movement or moving signals of the blue tooth mouse assembly 1 to the signal transmitting device 34, and then to the computer facilities 4 via the mouse control device 33 and the electric power supply circuit 32 and the USB interface device 31, such that the mouse module 3 may be communicated with the interface module 10, and then with the computer facilities 4.

The coordinate signals of the blue tooth mouse assembly 1 and/or the movement signals of the blue tooth mouse assembly 1 may thus be transmitted out from the interface module 10 to the computer facilities 4 of the users, in order to control or to operate the computer facilities 4.

The button control device 331 is coupled to the mouse control device 33, in order to control the mouse control device 33, or the interface module 10, or the computer facilities 4. For example, the button control device 331 may control the mouse control device 33 to send or transmit the coordinate signals and/or the movement signals of the blue tooth mouse assembly 1 from the signal transmitting device 34 to computer facilities 4, via the interface module 10.

In operation, the users of the computer facilities 4 may use the blue tooth mouse assembly 1 to operate the computer facilities 4, and to transmit the signals from the computer facilities 4 out to the other computer facilities 5, 6, and to receive the signals from the other computer facilities 5, 6 via the antenna 25, for allowing the end users 4, 5, 6 to be communicated with each other easily.

The blue tooth mouse assembly 1 may also be energized by the electric power source supplied to the computer facilities 4, such that additional electric power sources or batteries or the like are not required to be coupled to the blue tooth mouse assembly 1.

Accordingly, the blue tooth mouse assembly may be used for communicating the computer facilities of the users to the other end users wirelessly, or for allowing various computer facilities of the users to be easily communicated with each other.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A blue tooth mouse assembly comprising:
a) an interface module including a USB coupler for coupling to computer facility, and including an interface switching device coupled to said USB coupler,
b) a mouse module including:
i) an interface device coupled to said interface switching device of said interface module,
ii) an electric power supply circuit coupled to said interface device of said mouse module, to receive electric power from the computer facility, and
iii) a detecting device coupled to said electric power supply circuit, to detect and send coordinate signals and movement signals of said blue tooth mouse assembly to the computer facility via said interface device of said mouse module and said interface module, and
c) a blue tooth module including:
i) an interface device coupled to said interface switching device of said interface module,
ii) a signal transforming device coupled to said interface device of said blue tooth module, to transform signals to and from the computer facility, and
iii) an antenna coupled to said signal transforming device to receive and send signals from and out of the computer facility.

2. The blue tooth mouse assembly as claimed in claim 1, wherein said blue tooth module further includes an electric power supply device coupled to said interface device of said blue tooth module, to receive electric power from the computer facility.

3. The blue tooth mouse assembly as claimed in claim 1, wherein said blue tooth module further includes a blue tooth control device coupled to said signal transforming device of said blue tooth module.

4. The blue tooth mouse assembly as claimed in claim 1, wherein said mouse module further includes a mouse control device coupled to said electric power supply circuit of said mouse module, to control sending of said coordinate signals and movement signals of said blue tooth mouse assembly to the computer facility.

5. The blue tooth mouse assembly as claimed in claim 4, wherein said mouse module further includes a button control device coupled to said mouse control device, to control said mouse control device.

6. The blue tooth mouse assembly as claimed in claim 4, wherein said mouse module further includes a signals transmitting device coupled between said mouse control device and said detecting device, to transmit signals between said mouse control device and said detecting device.

7. A blue tooth mouse assembly comprising:
an interface module including a USB coupler for coupling to computer facility, and including an interface switching device coupled to said USB coupler,
a mouse module including an interface device coupled to said interface switching device of said interface module, and a detecting device coupled to said interface device, to detect and send coordinate signals and movement signals of said blue tooth mouse assembly to the computer facility via said interface device of said mouse module and said interface module, and
a blue tooth module including an interface device coupled to said interface switching device of said interface module, an electric power supply circuit coupled to said interface device of said blue tooth module, to receive electric power from the computer facility, and a signal transforming device coupled to said electric power supply circuit of said blue tooth module, to transform signals to and from the computer facility, and an antenna coupled to said signal transforming device to receive and send signals from and out of the computer facility.

8. The blue tooth mouse assembly as claimed in claim 7, wherein said mouth module further includes an electric power supply device coupled to said interface device of said mouse module, to receive electric power from the computer facility.

9. The blue tooth mouse assembly as claimed in claim 1, wherein said mouse module further includes a mouse control device coupled to said interface device of said mouse module, to control sending of said coordinate signals and movement signals of said blue tooth mouse assembly to the computer facility.

10. The blue tooth mouse assembly as claimed in claim 9, wherein said mouse module further includes a button control device coupled to said mouse control device, to control said mouse control device.

11. The blue tooth mouse assembly as claimed in claim 9, wherein said mouse module further includes a signals transmitting device coupled between said mouse control device and said detecting device, to transmit signals between said mouse control device and said detecting device.

12. The blue tooth mouse assembly as claimed in claim 7, wherein said blue tooth module further includes a blue tooth control device coupled to said signal transforming device of said blue tooth module.
